(19) United States
(12) Patent Application Publication
(10) Pub. No.: US 2023/0214677 A1
(43) Pub. Date: Jul. 6, 2023

(54) TECHNIQUES FOR EVALUATING AN EFFECT OF CHANGES TO MACHINE LEARNING MODELS

(71) Applicant: EQUIFAX INC., Atlanta, GA (US)

(72) Inventors: Royce ALFRED, Villa Rica, GA (US); Fan YIN, Atlanta, GA (US)

(21) Appl. No.: 18/147,967

(22) Filed: Dec. 29, 2022

Related U.S. Application Data
(60) Provisional application No. 63/295,266, filed on Dec. 30, 2021.

(51) Int. Cl. G06N 5/022

(52) U.S. Cl. CPC G06N 5/022

(57) ABSTRACT

An auditing system executes a first machine learning model on a first computing platform using input data to generate first output data. The auditing system executes a second machine learning model on a second computing platform using the input data to generate second output data. The second machine learning model is generated by migrating the first machine learning model to the second computing platform. The auditing system determines one or more performance metrics based on comparing the first output data to the second output data. The auditing system classifies, based on the one or more performance metrics, the second machine learning model with a classification. The classification comprises a passing classification or a failing classification. The auditing system causes the second model to be modified responsive to classifying the second model with a failing classification.

### CROSS REFERENCE TO RELATED APPLICATIONS

This application claims priority to U.S. Provisional Application No. 63/295,266 filed Dec. 30, 2021 and entitled “Techniques for Evaluating An Effect of Changes to Machine Learning Models,” the entire contents of which are incorporated herein by reference.

### TECHNICAL FIELD

The present disclosure relates generally to auditing of models. More specifically, but not by way of limitation, this disclosure relates to evaluating an effect of a change to a model.

### BACKGROUND

In conventional scoring models and attribute models, introducing changes (e.g., changes to how input data are weighted or considered, changes to model scoring method, etc.) may or may not significantly impact an output of a model. For example, a change to a model may result in a change in a number of rejected consumers for the same set of input data. A conventional method employed to determine an impact of a model change involves auditors manually determining descriptive statistics (e.g., performance metrics) for the model.

### SUMMARY

The present disclosure describes techniques for generating performance reports evaluating an effect of a change to a model. For example, an auditing system executes a first machine learning model on a first computing platform using input data to generate first output data. The auditing system executes a second machine learning model on a second computing platform using the input data to generate second output data. The second machine learning model is generated by migrating the first machine learning model to the second computing platform. The auditing system determines one or more performance metrics based on comparing the first output data to the second output data. The auditing system classifies, based on the one or more performance metrics, the second machine learning model with a classification. The classification comprises a passing classification or a failing classification. The auditing system causes the second model to be modified responsive to classifying the second model with a failing classification.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 includes a block diagram depicting an example of an operating environment for generating performance reports evaluating an effect of a change to a model, according to certain embodiments disclosed herein.

FIG. 1A includes a flow chart depicting an example of a process for utilizing an auditing system to predict a classification for a model, according to certain embodiments disclosed herein

FIG. 2 includes a flow diagram depicting an example of a process for updating a computing environment responsive to evaluating an effect of a change to a model, according to certain embodiments disclosed herein.

FIG. 3 depicts an example of determining key model data from the model output and of determining corresponding key updated model data from updated model output, according to certain embodiments disclosed herein.

FIG. 4 illustrates an example of determining key model data from the model output and of determining key updated model data, according to certain embodiments disclosed herein.

FIG. 5 illustrates determining performance metrics of a difference count and a difference percentage, among specific subsets of customers of the rejected, segregated according to rejection code, between the key model data and the key updated model data, according to certain embodiments disclosed herein.

FIG. 6 illustrates generating a compare matrix comparing counts of each subset of rejected customers from FIG. 5 according to a rejection code, according to certain embodiments disclosed herein.

FIG. 7 illustrates an example of determining key model data including a number and percentage of customers of various segments from the model output and the updated model output, according to certain embodiments disclosed herein.

FIG. 8 illustrates generating a compare matrix comparing counts of consumers in various segments, according to certain embodiments disclosed herein.

FIG. 9 illustrates an example of determining performance metrics comparing the output data and the respective output data, according to certain embodiments disclosed herein.

FIG. 10 illustrates an example of determining key model data and corresponding key updated model data, including both at the segment level and the overall level, according to certain embodiments disclosed herein.

FIG. 11 illustrates an example of determining key model data and key updated model data including a number and percentage of customers in the model output data 106 and the updated model output data, according to certain embodiments disclosed herein.

FIG. 12 illustrates, both in tabular form and graphical form, a count and percentage of consumers that did not have a score change, had a score change between various ranges, according to certain embodiments disclosed herein.

FIG. 13 illustrates an example of a compare matrix comparing a number of customers having a score change, between the outputs of the model and the updated model, in each of a number of bins in a valid score range, according to certain embodiments disclosed herein.

FIG. 14 illustrates score ranges for vantage and credit classifications, according to certain embodiments disclosed herein.

FIG. 15 illustrates an example of determining key model data and corresponding key updated model data, according to certain embodiments disclosed herein. In some instances, key model data and corresponding key updated model data are determined including a count of consumers, and a percentage of customers corresponding to each bin in both the model output data and the updated model output data. In some instances, key model data and corresponding key updated model data are determined, for each of the bins associated with the compare matrix of FIG. 13, a count of consumers, and a percentage of customers corresponding to each bin in both the model output data and the updated model output data.

FIG. 16 illustrates an example of determining a count and percentage difference between a number of customers in various subsets from the model output data to the updated model output data, according to certain embodiments disclosed herein.

FIG. 17 depicts an example performance report for an example updated scoring model, according to certain embodiments disclosed herein.

FIG. 18 illustrates an example of determining a number of customers in the model output and a number of consumers in the updated model output, according to certain embodiments disclosed herein.

FIG. 19 illustrates an example of comparing a distribution of change between subsets of scored and rejected consumers between the model output and the updated model output, according to certain embodiments disclosed herein.

FIG. 20 illustrates an example of measuring for all attributes with differences, according to certain embodiments disclosed herein.

FIG. 21 illustrates an example of determining a count and percentage difference between a number of customers in various subsets from the model output data to the updated model output data, according to certain embodiments disclosed herein.

FIG. 22 illustrates an example of calculating descriptive statistics on valid value differences for two example attributes, according to certain embodiments disclosed herein.

FIG. 23 illustrates an example performance report for an example attribute model, according to certain embodiments disclosed herein.

FIG. 24 includes a block diagram depicting an example of a computing device, according to certain embodiments disclosed herein.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary” or “example” is not necessarily to be construed as preferred or advantageous over other embodiments or designs.

Some aspects of the disclosure relate to updating a computing environment responsive to evaluating an effect of a change to a model. In one example, an auditing system may access a model. The model could be a scoring model (e.g., credit score model), an attribute model, or other type of model that, when applied to input data (e.g., panel data, archive data, time series data, and/or other data), generates an output (e.g., a score, a category designation from a set of categories, or other output). The model may be defined by one or more parameters. For example, the parameters could be rules for processing the input data (e.g., determining which of the input data to consider), rules determining the output (e.g., scoring rules), weights that are applied by the model, functions, and/or other parameters that encompass one or more of training the model, pre-processing input data, applying the model to input data, processing output data, or other process that involves the model or data input to and/or generated by the model. In some instances, the parameters can include a platform (e.g., a computing platform, a server, a mobile application, etc.) on which the model is applied to input data.

In certain examples, the auditing system determines that a change has been made or is to be made to one or more parameters of the model. For example, the change to the model could be a change in platform (e.g., a computing platform) that executes the model. In another example, the change to the model could be a change in one or more rules, weights, functions, or other parameters used by the model to process input data and determine an output. The auditing system may access both the model and an updated model which includes the change. The auditing system may access input data, apply the model to the input data, and separately apply the updated model to the input data. In an example where the change to the model is a change in a platform which applies the model from a first computing platform to a second computing platform, the auditing system can (1) apply, using a first computing platform, the model to the input data and also (2) apply the model to the input data using a second computing platform. In this example, the model is the model executed by the first computing platform and the updated model is the model executed by the second computing platform.

The auditing system can determine each of a set of performance metrics for comparing the updated model to the model based on the output of the respective models. The auditing system can extract key output data from the model and the key updated output data from the updated model and calculate the set of performance metrics from the key output data and corresponding key updated output data. For example, the key output data could include a number of entities (e.g., 100) in a particular category from the model output data and the key updated output data could include a corresponding number of entities (e.g., 150) in the particular category from the updated model output data. In this example, the performance indicator could be an increase/decrease in the number of entities in the particular category (e.g., +50, +50%) between the model output data and the updated model output data. The auditing system may determine, for each performance metric comparing the updated model to the model, whether the respective performance metric meets a predefined criteria (.e.g the performance metric must be equal to a predefined value, the performance metric must be greater than a predefined value, the performance metric must be less than a predefined value, the performance metric must be of a predefined category, etc.).

The auditing system may generate a final diagnosis or designation (e.g., pass or fail) for the updated model based on the results of each performance metric (e.g., whether each performance metric meets an associated predefined criteria) of the set of performance metrics. For example, the auditing system may assign a “pass” designation to the new model if each of the set of performance metrics comparing the updated model to the model meet respective predefined criteria. In this example, the auditing system assign a “fail” designation to the updated model if one or more of the performance metrics does not meet respective predefined criteria. Based on the final diagnosis, the auditing system or another system may perform a process. For example, the auditing system or another system may pause a data migration to a new computing platform upon which the new model will be executed responsive to determining a “fail” designation for the updated model. In another example, responsive to determining a “fail” designation for the updated model, the auditing system or another system may iteratively change one or more parameters (e.g., weights, input data pre-processing rules, formulas, etc.) of the updated model and determine another final diagnosis through analysis of performance metrics as described above until a “pass” designation for the updated model is obtained. Further, the auditing system or another system may generate a performance report that indicates the performance metrics of the updated model, whether each performance metric meets a predefined criterion, as well as a final designation (e.g., pass or fail) for the updated model.

As described herein, certain aspects provide improvements to conventional model auditing systems by dynamically updating a computing environment responsive to evaluating an effect of a change to a model. For example, certain aspects described herein enable updating a computing environment through pausing, stopping, or otherwise modifying a data migration process from a first computing platform to a second computing platform responsive to determining a negative effect of changing the platform upon which the model will be executed. For example, certain aspects described herein enable alerting one or more computing systems (e.g., a computing platform that executes the updated model) to a detected negative effect of the change. Such dynamic updating of computing environments responsive to evaluating an effect of a change to a model may reduce the network bandwidth because computing environment processes associated with executing a model for which a negative effect of a change is determined can be paused. Also, certain aspects described herein enable dynamically modifying model parameters to achieve a desirable implementation of the updated model as indicated by determining performance metrics that compare the updated model to an existing version of the model. Such dynamic modification of model parameters can reduce network downtime by eliminating a need for operator intervention to change model parameters.

Using methods described herein to evaluate an effect of a change to a model can facilitate the adaptation of an operating environment based on determining a negative effect on the model of the change. For example, adaptation of the operating environment can include granting or denying access to users. Thus, certain aspects can effect improvements to machine-implemented operating environments that are adaptable based on the predicted effect of changes to a model with respect to those operating environments.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

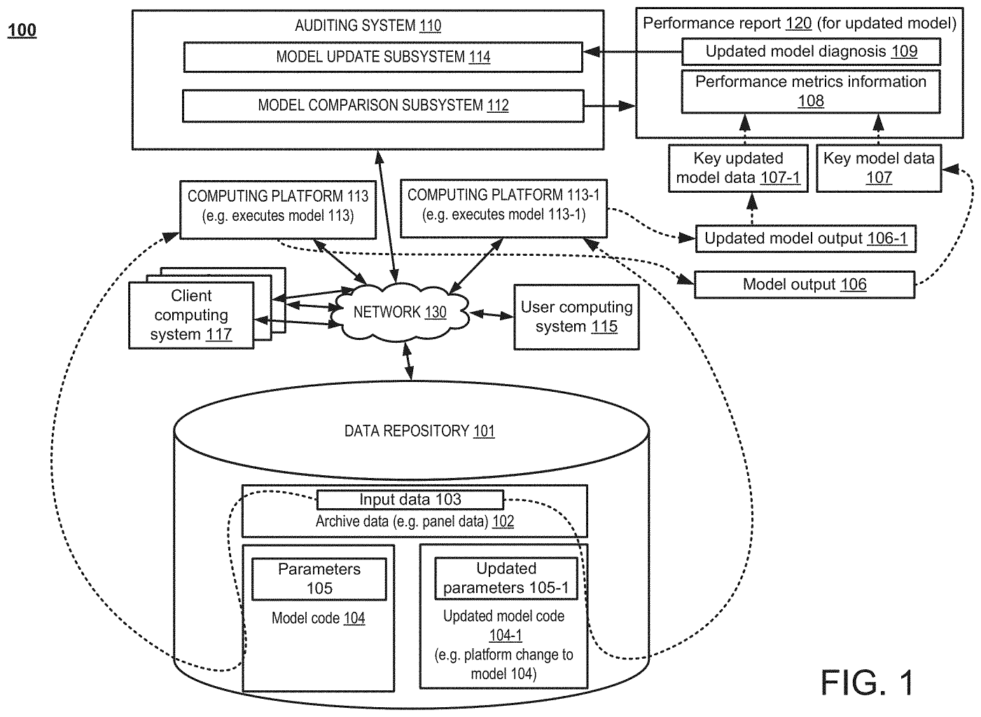

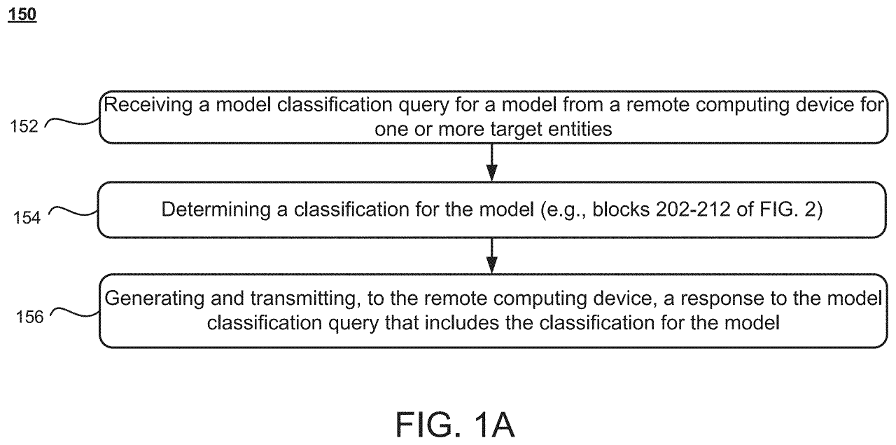

FIG. 1 is a block diagram depicting an example of an operating environment 100 for generating performance reports evaluating an effect of a change to a model, according to certain aspects of the present disclosure. The operating environment 100 includes an auditing system 110 that has access to a source data repository 101, for example, over a network 130. The auditing system 110 can include a model update subsystem 114 and a model comparison subsystem 112. In certain embodiments, the auditing system 110 can communicate with a computing platform 113 via the network 130. The computing platform 113 can provide a service such as providing an execution computing environment for a model including computing components and libraries invoked by the model. The model could be a scoring model, an attribute model, or other type of model. The output data could be a score or a category designation for a set of input data 103. The input data 103 could be selected from or otherwise be determined based on archive data 102. Archive data could be panel data, credit panel data, monthly credit data archives, or other archive data. In some instances, the auditing system 110 communicates, via the network 130, with one or more additional computing platforms in addition to computing platform 113, for example, with a computing platform 113-1.

In some embodiments, the model comparison subsystem 112 can generate a performance report 120 that compares an updated model output 106-1 to a model output 106 when both the model and the updated model are applied to a set of input data 103. The updated model includes updated parameters 105-1 that in some instances include one or more differences from parameters 105 of the model. Parameters 105 and/or updated parameters 105-1 can include rules for processing the input data (e.g. determining which of the input data to consider), rules determining the output (e.g. scoring rules), weights that are applied by the model, functions, and/or other parameters that encompass one or more of training the model, pre-processing input data, applying the model to input data, processing output data, or other process that involves the model or data input to and/or generated by the model. In some instances, the parameters can include a platform (e.g., a computing platform, a server, a mobile application, etc.) on which the model is applied to input data. Accordingly, the change in parameters between the model and the updated model could include a change in one or more of the rules for processing the input data, the rules determining the output, the weights that are applied by the model, the functions, and/or the other parameters that encompass one or more of training the model, pre-processing input data, applying the model to input data, processing output data, or other process that involves the model or data input to and/or generated by the model. In some instances, the parameters can include a platform (e.g., a computing platform, a server, a mobile application, etc.) on which the model is applied to input data. In some embodiments, the updated parameters 105-1 of the updated model are the same as the parameters 105 of the model except a parameter defining which platform executes the updated model is different. For example, as depicted in FIG. 1, the updated model may be executed on a different computing platform. The updated model can be executed by computing platform 113-1 instead of by computing platform 113. In this example, the auditing system 110 may receive a notification of a planned migration of data (including the model) from the computing platform 113 and the data repository 101 to the computing platform 113-1 and an associated data repository (separate from the data repository 101) and may generate, responsive to receiving the notification, the performance report 108 to determine if the model will execute correctly on computing platform 113-1. In this example, responsive to determining that the model will execute correctly on the computing platform 113-1, the auditing system 110 validates data migrated to the computing platform 113-1 and its associated data repository to determine that it corresponds to (e.g., that it is the same as) the data of the computing platform 113 and the data repository 101. However, in other embodiments, the updated model is executed on the same computing platform 113 as the model. For example, in these other instances, the auditing system 110 may receive a notification of a planned change in model parameters 105 and generate, responsive to receiving the notification, the performance report 120 to determine if the model will execute correctly using the updated model parameters 105-1.

In certain embodiments, when generating a performance report 120, as depicted in FIG. 1, the model comparison subsystem 112 may determine a model output 106 by applying the model to the input data 103 and may determine an updated model output 106-1 by applying the updated model to the input data 103. For example, both the model and the updated model are applied, respectively, to the same input data 103. In certain embodiments, determining the model output 106 includes communicating with the computing platform 113, which executes the model code 104 and applies the model to the input data 103 to determine the model output 106, and determining the updated model output 106-1 includes communicating with the computing platform 113-1, which executes the updated model code 104-1 and applies the updated model to the input data 103 to determine the updated model output 106-1. In other embodiments, determining the model output 106 and the updated model output 106-1 includes communicating with the computing platform 113, which executes both the model code 104 and the updated model code 104-1 and applies both the model and the updated model to the input data 103 to determine the model output 106 and the updated model output 106-1, respectively.

In certain embodiments, the model comparison subsystem 112 generates model performance metrics 107 based on the model output 106 and generates updated model performance metrics 107-1 based on the updated model output 106-1. For example, the performance metrics can include a percentage of differences, a change in a scorable population, an average absolute difference, a maximum absolute threshold, a difference in number of observations, a difference in number of columns, or other performance metrics. The set of updated model performance metrics 107-1 corresponds to the set of model performance metrics 107. For example, the updated model performance metrics 107-1 include a value for each of a set of performance metrics and the set of model performance metrics 107 include a value for each of the set of performance metrics.

The model comparison subsystem 112 can compare, for each performance metric, a key value from the model output 106 (e.g., key model data 107) to a corresponding key value of the updated model output 106-1 (e.g., key updated model data 107-1). In some instances, the model comparison subsystem 112 determines, by comparing corresponding values between the key model data 107 and the key updated model data 107-1, a set of performance metrics. For each performance metric of the set of performance metrics, the model comparison subsystem 112 determines either that the performance metric meets a predefined criteria or does not meet a predefined criterion. In some instances, the predefined criterion is a match between the key values used to determine the performance metric. In some instances, the predefined criterion is a performance metric indicating a difference (e.g., a percentage difference, a numerical difference, etc.) between key values that is less than a threshold. Other predefined criteria can be used. In some instances, the model comparison subsystem 112 generates performance metric information 108 including values for each performance metric and, for each performance metric, a designation based on whether the performance metric meets the predefined criteria or not. For example, the model comparison subsystem 112 assigns a “pass” designation to a performance metric if the performance metric meets the predefined criteria and a “fail” designation to the performance metric if the performance metric does not meet the predefined criteria. In some instances, based on the performance metric information 108, including a designation identifying whether each performance metric meets respective predefined criteria, the model comparison subsystem 112 determines an updated model diagnosis 109. For example, the updated model diagnosis 109 may be determined based on a number of performance metrics that meet predefined criteria. In some instances, the model comparison subsystem 112 assigns an updated model diagnosis 109 of “pass” of all of the performance metrics are assigned a “pass” designation (e.g., if each of the performance metrics meets a respective predefined criterion) and assigns an updated model diagnosis 109 of “fail” if one or more of the performance metrics is assigned a “fail” designation (e.g., if one or more of the performance metrics does not meet predefined criteria. In other instances, the model comparison subsystem 112 assigns an updated model diagnosis 109 of “pass” if a threshold number or threshold percentage of performance metrics are assigned a “pass” designation.

In certain embodiments, as depicted in FIG. 1, the model update subsystem 114 can perform a process based the updated model diagnosis 109. In some instances, the model update subsystem 114 receives a “fail” updated model diagnosis 109 and performing the process involves changing one or more of the updated parameters 105-1 to attempt to correct issues identified by particular performance metrics which caused the updated model diagnosis 109 to indicate a “fail” designation. For example, performing the process can involve iteratively (1) changing one or more parameters 105-1 of the updated model and (2) generating a subsequent performance report until receipt of an updated model diagnosis 109 of “pass.” Generating the subsequent performance report 120 can include applying the model as well as the updated model with the changed one or more parameters 105-1 to the input data 103 to generate a model output 106 and an updated model output 106-1, respectively, from which the subsequent performance report can be generated. In certain embodiments, performing a process responsive to receiving the updated model diagnosis 109 includes alerting one or more systems, via the network 130, of the updated model diagnosis 109. For example, responsive to receiving a “fail” updated model diagnosis 109, the model update subsystem 114 can alert the computing platform 113 and/or the computing platform 113-1 that there are problems with implementation of the updated model. In certain embodiments, performing a process responsive to receiving the updated model diagnosis 109 can include pausing a data migration process. For example, the model update subsystem 114 pauses a migration of data from computing platform 113 to computing platform 113-1 responsive to receiving the “fail” updated model diagnosis 109. Other appropriate processes may be performed responsive to receiving the updated model diagnosis 109, including scheduling or re-scheduling a data migration process, scheduling or rescheduling a launch of implementation of the new model. In some instances, the model update subsystem 114, responsive to receiving a “pass” updated model diagnosis 109, alerts the computing platform 113 and/or the computing platform 113-1 of the updated model diagnosis 109.

The network 130 could be a data network that may include one or more of a variety of different types of networks, including a wireless network, a wired network, or a combination of a wired and wireless network. Examples of suitable networks include a local-area network (“LAN”), a wide-area network (“WAN”), a wireless local area network (“WLAN”), the Internet, or any other networking topology known in the art that can connect devices as described herein. A wireless network may include a wireless interface or a combination of wireless interfaces. The wired or wireless networks may be implemented using routers, access points, bridges, gateways, or the like, to connect devices in the operating environment 100.

The data repository 101 may be accessible to the audit system 110 via the network 120 and to the computing platform 113. In certain embodiments in which data is migrated from the computing platform 113 to the computing platform 113-1, the computing platform 113-1 is associated with its own data repository (separate from the data repository 101) that performs one or more functions that are similar to the data repository 101. The data repository 101 may store archive data 102. The archive data 102 could include data archives, for example panel data stored as source data files that each include multiple data records with attribute data for one or more entities. For example, each data record can include multiple attributes. In some examples, the source data files may be tables, the data records may be table rows, and the attributes may be table columns. In some examples, the archive data 102 may include large-scale datasets containing large numbers of data records and attributes. For example, the source data files could include multiple million data records with each data record having over hundreds of attributes.

The data repository 101 can store a model code 104 including a set of parameters 105. The model code 104 may enable the audit system 110 to execute a model defined by the parameters 105 via a computing platform 113. The model could include a scoring model or an attribute model which, when applied to a set of input data 103, generates a model output 104. The parameters 105 can be rules for processing the input data (e.g., determining which of the input data to consider), rules determining the output (e.g., scoring rules), weights that are applied by the model, functions, and/or other parameters that encompass one or more of training the model, pre-processing input data, applying the model to input data, processing output data, or other process that involves the model or data input to and/or generated by the model. The input data 103 may be a subset of or can be otherwise determined based on the archive data 102. In some instances, the data repository stores an updated model code 104-1 including an updated set of parameters 105-1. The updated parameters 105-1, in some instances, can be the parameters 105 with one or more changes. In some embodiments, as depicted in FIG. 1, the change between the parameters 105 of the model code 104 and the parameters 105-1 of the updated model code 104-1 include a computing platform change from computing platform 113 to computing platform 113-1.

In some instances, the data repository 101 can store model outputs 106 generated by applying the model to the input data 103 and can store updated model outputs 106-1 generated by applying the updated model to the input data 103. In some instances, the data repository can store key model data 107 extracted or otherwise determined based on the model output 106 and key updated model data 107-1 extracted or otherwise determined based on the model output 106-1. In some instances, the data repository 101 can store performance metric information 108 that indicates a set of performance metrics determined by the model comparison subsystem 112 by comparing corresponding data from the key model data 107 and the key updated model data 107-1. The performance report 120, in some embodiments, can further include a designation, for each of the set of performance metrics, whether the respective performance metric meets a respective predefined criterion or does not meet a respective predefined criterion. In some instances, the data repository 101 can store an updated model diagnosis 109 determined by the model comparison subsystem 112. In some instances, the data repository 101 can store the performance report 120 for the updated model that includes one or more of the updated model diagnoses 109, the performance metric information 108, the key model data 107, the key updated model data 107-1, the model output 106, and the updated model output 106-1.

In some instances, model output 106 and/or updated model output 106-1 can be utilized to modify a data structure in the memory or a data storage device. For example, the model output 106 and/or the updated model output 106-1 and/or one or more explanation codes can be utilized to reorganize, flag, or otherwise change the input data 103 involved in the prediction by the model. For instance, input data 103 (e.g., generated based on archive data 102) can be attached with flags indicating their respective amount of impact on the risk indicator. Different flags can be utilized for different input data 103 to indicate different levels of impacts. Additionally, or alternatively, the locations of the input data 103 in the storage, such as the data repository 101, can be changed so that the input data 103 are ordered, ascendingly or descendingly, according to their respective amounts of impact on the risk indicator.

By modifying the input data 103 in this way, a more coherent data structure can be established which enables the data to be searched more easily. In addition, further analysis of the the model and the model output 106 and/or updated model output 106-1 can be performed more efficiently. For instance, input data 103 having the most impact on the output data 106 and/or the updated output data 106-1 can be retrieved and identified more quickly based on the flags and/or their locations in the entity data repository 101. Further, updating the model such as re-training the model based on new values of the input data 103, can be performed more efficiently especially when computing resources are limited. For example, updating or retraining the model can be performed by incorporating new values of the input data 103 having the most impact on the output risk indicator based on the attached flags without utilizing new values of all the input data 103.

Furthermore, the auditing system 110 can communicate with various other computing systems, such as client computing systems 117. For example, client computing systems 117 may send a query for a classification of a model to the auditing system 110, or may send signals to the auditing system 110 that control or otherwise influence different aspects of the auditing system 110. For example, the client computing system 117 may use a first computing platform 113 to execute a model and wish to migrate the model to a second computing platform 113-1 and requests a classification for the migrated model (e.g., either a pass or fail classification). In another example, the client computing system 117 may use a model and wish to make modifications to the model and requests a classification for the modified model (e.g., either a pass or fail classification). The client computing systems 117 may also interact with user computing systems 115 via one or more public data networks 130 to facilitate interactions between users of the user computing systems 117 and interactive computing environments provided by the client computing systems 115.

Each client computing system 117 may include one or more third-party devices, such as individual servers or groups of servers operating in a distributed manner. A client computing system 117 can include any computing device or group of computing devices operated by a seller, lender, or other providers of products or services. The client computing system 117 can include one or more server devices. The one or more server devices can include or can otherwise access one or more non-transitory computer-readable media. The client computing system 117 can also execute instructions that provide an interactive computing environment accessible to user computing systems 115. Examples of the interactive computing environment include a mobile application specific to a particular client computing system 117, a web-based application accessible via a mobile device, etc. The executable instructions are stored in one or more non-transitory computer-readable media.

The client computing system 117 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system 115 to access various functions of the interactive computing environment. For instance, the interactive computing environment may transmit data to and receive data from a user computing system 115 to shift between different states of the interactive computing environment, where the different states allow one or more electronics transactions between the user computing system 115 and the client computing system 117 to be performed.

In some examples, a client computing system 117 may have other computing resources associated therewith (not shown in FIG. 1), such as server computers hosting and managing virtual machine instances for providing cloud computing services, server computers hosting and managing online storage resources for users, server computers for providing database services, and others. The interaction between the user computing system 115 and the client computing system 117 may be performed through graphical user interfaces presented by the client computing system 117 to the user computing system 115, or through an application programming interface (API) calls or web service calls.

A user computing system 115 can include any computing device or other communication device operated by a user, such as a user or a customer. The user computing system 115 can include one or more computing devices, such as laptops, smart phones, and other personal computing devices. A user computing system 115 can include executable instructions stored in one or more non-transitory computer-readable media. The user computing system 115 can also include one or more processing devices that are capable of executing program code to perform operations described herein. In various examples, the user computing system 115 can allow a user to access certain online services from a client computing system 117, to engage in mobile commerce with a client computing system 117, to obtain controlled access to electronic content hosted by the client computing system 117, etc.

For instance, the user can use the user computing system 115 to engage in an electronic transaction with a client computing system 117 via an interactive computing environment. An electronic transaction between the user computing system 115 and the client computing system 117 can include, for example, the user computing system 115 being used to request online storage resources managed by the client computing system 117, acquire cloud computing resources (e.g., virtual machine instances), and so on. An electronic transaction between the user computing system 115 and the client computing system 117 can also include, for example, query a set of sensitive or other controlled data, access online financial services provided via the interactive computing environment, submit an online credit card application or other digital application to the client computing system 117 via the interactive computing environment, operating an electronic tool within an interactive computing environment hosted by the client computing system (e.g., a content-modification feature, an application-processing feature, etc.).

In some aspects, an interactive computing environment implemented through a client computing system 117 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 115 can be used to request access to the interactive computing environment provided by the client computing system 117, which can selectively grant or deny access to various electronic functions. Based on the request, the client computing system 117 can collect data associated with the user and communicate with the auditing system 110 for model classification (e.g, for migration of a model between platforms 113 and 113-1, or for a modified model). Based on the model classification (e.g., a pass classification or a fail classification) predicted by the auditing system 110, the client computing system 117 can determine whether to grant the access request of the user computing system 115 to certain features of the interactive computing environment. For example, the auditing system 110 may deny access to one or more user computing systems 115 responsive to determining that the model has a fail classification and may grant access to one or more user computing systems 115 responsive to determining that the model has a pass classification.

The model classification can be utilized by the client computing system 117 to determine the risk associated with an entity accessing a service provided by the client computing system 117, thereby granting or denying access by the entity to an interactive computing environment implementing the service. For example, the client computing system 117 associated with the service provider can generate or otherwise provide access permission, in accordance with the model classification determined by the auditing system 110, to user computing systems 115 that request access. The access permission can include, for example, cryptographic keys used to generate valid access credentials or decryption keys used to decrypt access credentials. The client computing system 117 associated with the service provider can also allocate resources to the user and provide a dedicated web address for the allocated resources to the user computing system 115, for example, by adding it in the access permission. With the obtained access credentials and/or the dedicated web address, the user computing system 115 can establish a secure network connection to the computing environment hosted by the client computing system 117 and access the resources via invoking API calls, web service calls, HTTP requests, or other proper mechanisms.

While FIG. 1 shows that the data repository 101 is accessible to the auditing system 110 and the computing platforms 113 and 113-1 through the network 130, the data repository 101 may be directly accessible by the processors located in the auditing system 110, the computing platform 113, and the computing platform 113-1. In some aspects, the network-attached storage units may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory or memory devices.

The number of devices depicted in FIG. 1 are provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the auditing system 110, the computing platforms 113/113-1, and the data repository 101, may be instead implemented in a single device or system.

FIG. 1A is a flow chart depicting an example of a process 150 for utilizing an auditing system 110 to predict a classification for a model. One or more computing devices (e.g., the auditing system 110) implement operations depicted in FIG. 1A by executing suitable program code. For illustrative purposes, the process 150 is described with reference to certain examples depicted in the figures. Other implementations, however, are possible.

At block 152, the process 150 involves receiving a model classification query for a model from a remote computing device for one or more target entities. The remote computing device can be a client computing system 117 that provides one or more services the one or more target entities, which comprise one or more user computing systems 115. The model classification query can also be received by the auditing system 110 from a remote computing device associated with an entity authorized to request model classification for the model. In some instances, the model classification query is for a first model that includes one or more modifications to a second model that the client computing system 117 already uses. The one or more modifications could include a modification to the platform upon which the model is to be executed (e.g., transitioning from platform 113 to platform 113-1), a modification to one or more parameters of the model, and/or other modifications.

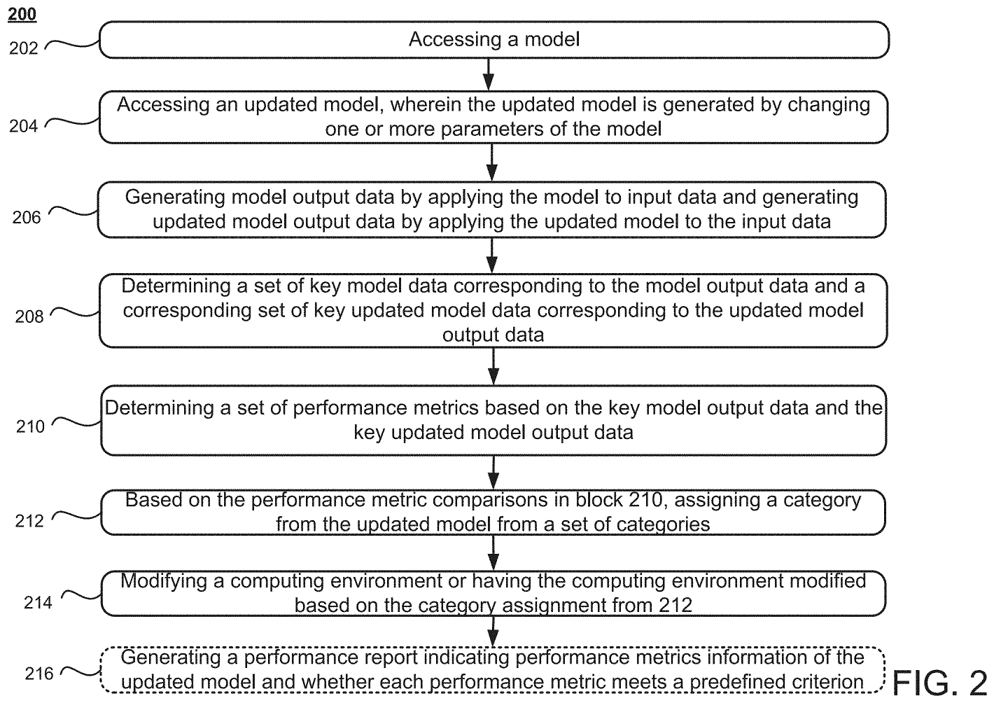

At block 154, the process 150 involves determining a classification for the model. Further details for determining a category/classification for the model are described herein in FIG. 2 at blocks 202-212. For example, the auditing system 110 can access a model as well as the updated model associated with the query (e.g., a first model associated with the query includes one or more changes made to a second model). The auditing system 110 can generate model output data 116 and updated model output data 116-1 by applying the second model and the first model, respectively, to a set of input data. The auditing system 110 can determine a set of key model data 107 and key updated model data 107-1 based on the data 116 and 116-1, determine a set of performance metrics 108 based on the data 107 and 107-1, and generate a performance report 120 for the first model based on the performance metrics 108. Based on the performance report 120, the auditing system 110 can classify the first model with a classification/category (e.g., a pass category, a fail category).

At block 156, the process 150 involves generating and transmitting a response to the model classification query that includes the classification for the model. The classification (or category) of the model can be used for one or more operations that involve performing an operation with respect to the target entities based on the model classification. In one example, the model classification can be utilized to control access to one or more interactive computing environments by the target entity. For example, one or more user computing systems 115 are not allowed to access services provided using the model responsive to determining a fail classification for the model, and the one or more user computing systems 115 are allowed to access the services responsive to determining a pass classification for the model. As discussed above with regard to FIG. 1, the auditing system 110 can communicate with client computing systems 117, which may send model classification queries to the auditing system 110 to request classifications for models. The client computing systems 117 may be associated with technological providers, such as cloud computing providers, online storage providers, or financial institutions such as banks, credit unions, credit-card companies, insurance companies, or other types of organizations. The client computing systems 115 may be implemented to provide interactive computing environments for users to access various services offered by these service providers. Users can utilize user computing systems 115 to access the interactive computing environments thereby accessing the services provided by these providers.

For example, one or more users can submit a request to access the interactive computing environment using user computing system(s) 115. Based on the request(s), the client computing system 117 can generate and submit model classification query to the auditing system 110. The model classification query can include, for example, an identity of the model. The auditing system 110 can determine a classification for the model, for example, by performing the steps of FIG. 2 at blocks 202-212. The auditing system 110 can return a classification for the model to the remote computing device associated with the client computing system 117.

Based on the received classification for the model, the client computing system 117 can determine whether to grant customers access to the interactive computing environment. If the client computing system 117 determines that the classification received from the auditing system 110 for the model is a fail classification, for instance, the client computing system 117 can deny access by customers to the interactive computing environment. For example, denying access can include denying access to services provided by the client computing system 117 which involve applying the model associated with the fail classification. Conversely, if the client computing system 117 determines that the classification received from the auditing system 110 for the model is a pass classification, the client computing system 117 can grant access to the interactive computing environment by the customers and the customers would be able to utilize the various services provided by the service providers. For example, with the granted access, the customers can utilize the user computing system(s) 115 to access clouding computing resources, online storage resources, web pages or other user interfaces provided by the client computing system 117 to execute applications, store data, query data, submit an online digital application, operate electronic tools, or perform various other operations within the interactive computing environment hosted by the client computing system 117.

FIG. 2 includes a flow diagram depicting an example of a process for updating a computing environment responsive to evaluating an effect of a change to a model, according to certain aspects of the present disclosure. The auditing system 110, including the update subsystem 114 and/or the comparison subsystem 112, can implement operations depicted in FIG. 2 by executing suitable program code.

At block 202, the process 200 involves accessing a model. Accessing the model can involve accessing, by the model comparison subsystem 112, a model code 104 including a set of parameters 105. The model code 104 may enable the audit system 110 to execute a model defined by the parameters 105 via a computing platform 113. The model could include a scoring model or an attribute model. The parameters 105 can be rules for processing the input data (e.g., determining which of the input data to consider), rules determining the output (e.g., scoring rules), weights that are applied by the model, functions, and/or other parameters that encompass one or more of training the model, pre-processing input data, applying the model to input data, processing output data, or other process that involves the model or data input to and/or generated by the model.

At block 204, the process 200 involves accessing an updated model, wherein the updated model is generated by changing one or more parameters 105 of the model. Accessing the updated model can involve accessing, by the model comparison subsystem 112, an updated model code 104-1 including a set of updated parameters 105-1. The updated model code 104-1 may enable the audit system 110 to execute the updated model defined by the parameters 105-1 via a computing platform 113. The model could include a scoring model or an attribute model. In certain embodiments, an operator of the auditing system 110 can make changes to one or more parameters 105 of the model, for example, changing one or more of rules for processing the input data, rules determining the output, weights that are applied by the model, functions, and/or other parameters that encompass one or more of training the model, pre-processing input data, applying the model to input data, processing output data, or other process that involves the model or data input to and/or generated by the model. The operator of the auditing system 110 can create the updated model code 104-1.

At block 206, the process 200 involves generating model output 106 data by applying the model to input data and generating updated model output 106-1 data by applying the updated model to the input data. For example, the model comparison subsystem 112 communicates instructions to the computing platform 113 to apply the model to the input data 102 and the computing platform 113 applies the model to the input data 102 to generate the model output 106 data. In certain embodiments, the model comparison subsystem 112 further communicates instructions to the computing platform 113 to apply the updated model to the input data 102 and the computing platform 113 applies the updated model to the input data 102 to generate the updated model output 106-1 data. In other embodiments (e.g., as depicted in FIG. 1), the model comparison subsystem 112 communicates instructions to the computing platform 113-1 to apply the updated model to the input data 103 and the computing platform 113-1 applies the updated model to the input data 103 to generate the updated model output 106-1 data.

In some instances, the model output 106 data and/or the updated model output 106-1 data includes one or more scores, categories, values, or other data for one or more entities generated by applying the model and/or the updated model to the input data 103. For example, the model output 106 data and/or the updated model output 106-1 data could include, for a set of entities, a binary category designation, for example, a rejected category (e.g., credit rejected) or a scored category (e.g., assigned a credit score). In some instances, the output data could include a segment category for each entity (e.g., one of a set of credit score ranges). In some instances, one or more category data of the output data include associated codes (e.g., reject codes).

At block 208, the process 200 involves determining a set of key model data 107 corresponding to the model output data 106 and a corresponding set of key updated model data 107-1 corresponding to the updated model output data 107. In some instances, corresponding pairs of key model data 107 and key updated model data 107-1 values may be used to construct performance metrics for comparing the updated model to the model. For example, the value in the key data 107 can be 100 (e.g., a number of rejected entities in a particular category in the model output data 106) and a corresponding value in the key updated output data 107-1 can be 110 (e.g., a number of rejected entities in the particular category in the updated model output data 106-1).

At block 210, the process 200 involves determining a set of performance metrics based on the key model output data 107 and the key updated model output data 107-1 and determining, for each of the set of performance metrics, whether the performance metric meets or does not meet a respective predefined criterion. Continuing with a previous example, if a key value (from the key model output data 107) is 100 and a corresponding key value (from the key updated model data 107-1) is 110, the performance metric can be 10% (e.g., representing an increase of 10% from the value of 100 to the corresponding value of 110). In certain examples, performance metrics can be calculated based on comparing other performance metrics. Because the performance metric is determined using output data generated by both models from common input data 103, the performance metric represents an effect of the change from the model to the updated model.

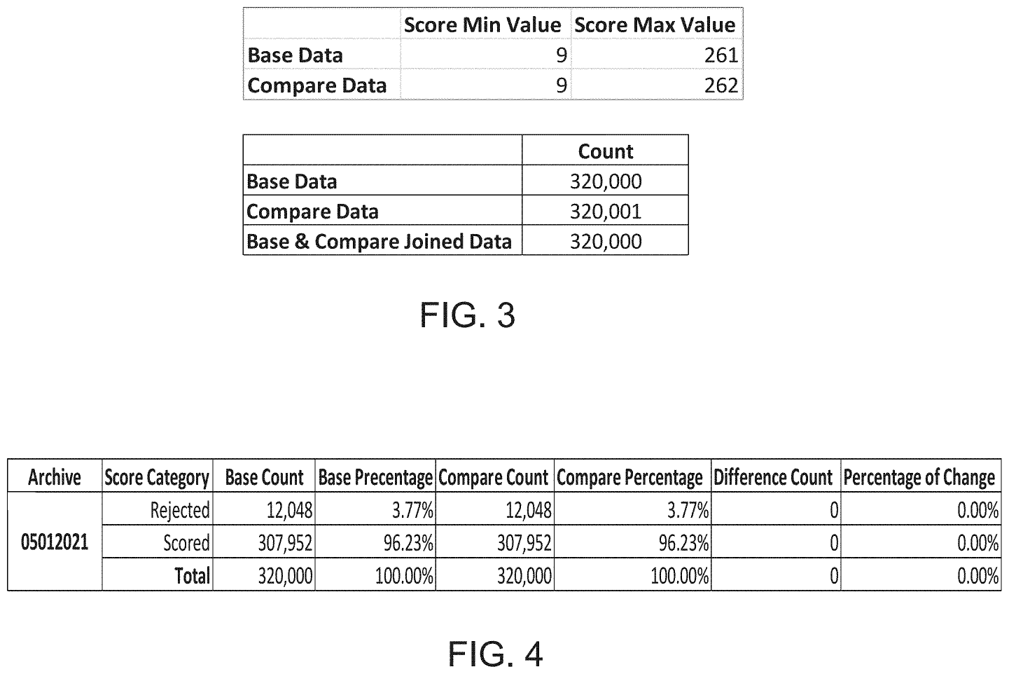

FIGS. 3-16 illustrate an example of determining key model data 107, key updated model data 107-1, and performance metric information 108 for an example scoring model.

FIG. 3 illustrates an example of determining key model data 107 including a minimum and maximum score value and a number of customers from the model output 106 and of determining corresponding key updated model data 107-1 including a minimum and maximum score value and a number of customers from updated model output 106-1. As illustrated in FIG. 3, the model comparison subsystem 112 determines this key model data 107 (“base data”) and this key updated model data 107-1 (“compare data”). The base and compare joined data represents the number of consumers shared between the base data and the compare data.

FIG. 4 illustrates an example of determining key model data 107 including a number and percentage of each of rejected and scored customers from the model output 106 (e.g. “rejected base count,” “scored base count,” “rejected base percentage,” and “scored base percentage”) and of determining key updated model data 107-1 including a number of percentage of rejected and scored customers from the updated model output 106-1 (e.g. “rejected compare count,” “scored compare count,” “rejected compare percentage,” and “scored compare percentage”). The numerical amounts of rejected and scored customers are determined from the data in FIG. 3. The percentage values are determined based on the numerical values. As illustrated in FIG. 4, the model comparison subsystem 112 can determine a set of performance metrics comparing (1) a numerical and a percentage difference between a count of rejected customers between the key model data 107 and the key updated model data 107-1, (2) a numerical and a percentage difference between a count of scored customers between the key model data 107 and the key updated model data 107-1. As illustrated in FIG. 4, the model comparison subsystem 112 can also determine performance metrics comparing a difference in total and percentage count of the customers associated with both the updated model output 106-1 and the model output 106.

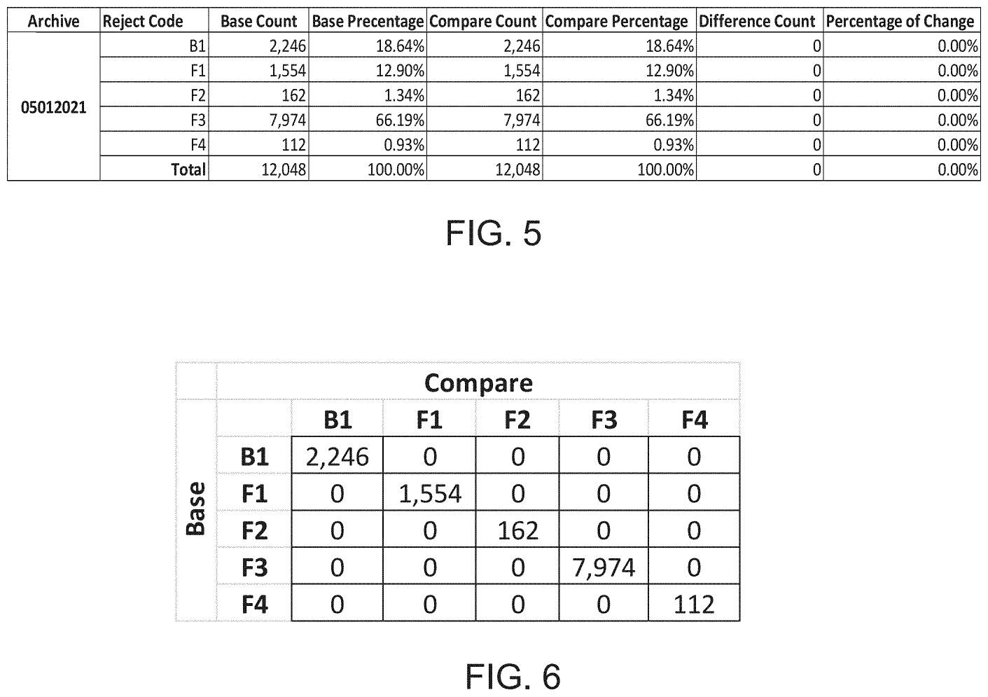

FIG. 5. illustrates determining performance metrics of a difference count and a difference percentage, among specific subsets of customers of the rejected, segregated according to rejection code (e.g., B1, F1, F2, F3, F4), between the key model data 107 and the key updated model data 107-1. The values of the compare matrix correspond to values in the table of FIG. 4.

FIG. 6 illustrates generating a compare matrix comparing counts of each subset of rejected customers from FIG. 5 according to a rejection code. As illustrated in FIG. 6, the compare matrix values falling along a center diagonal line of the compare matrix indicates that the distribution of customers in each specific rejection code group is the same in both the model output data 106 and the updated output data 106-1. If the distribution between the respective output data 106 and 106-1 were different, one or more of the zero values in the matrix would include a non-zero value, indicating that the distributions of rejected customers do not exactly correspond.

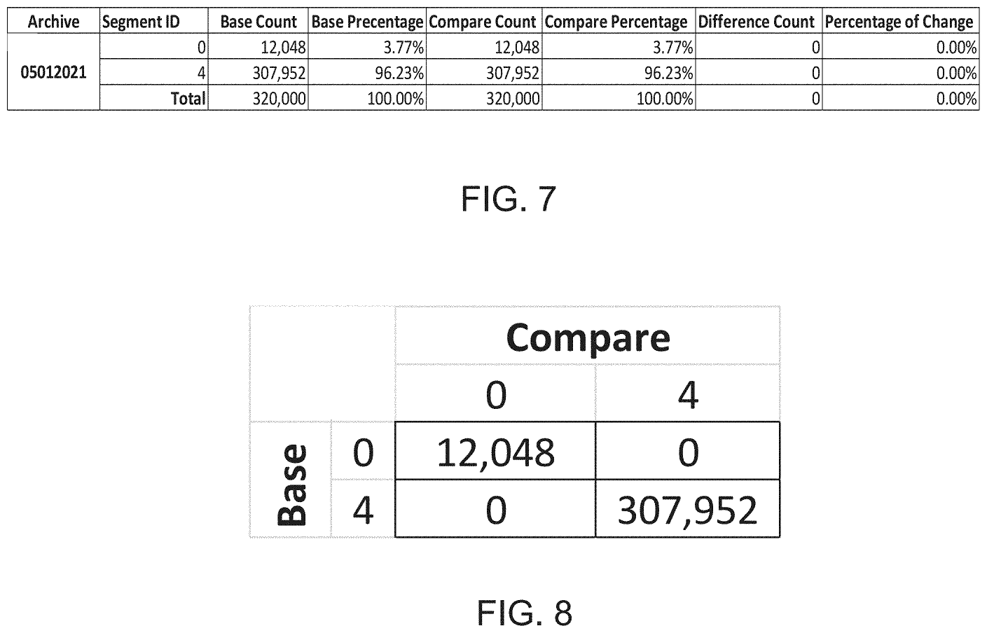

FIG. 7 illustrates an example of determining key model data 107 including a number and percentage of customers of various segments from the model output 106 and the updated model output 106-1 (e.g., “base count,” “base percentage,” “compare count,” and “compare percentage,” “difference count,” and “percentage of change”). The numerical amounts are determined from the data in FIG. 3.

FIG. 8 illustrates generating a compare matrix comparing counts of consumers in various segments (e.g., two segments “4” and “0” are depicted in FIG. 7. However other numbers of segments may be used) As illustrated in FIG. 8, the compare matrix values falling along a center diagonal line of the compare matrix indicates that the distribution of customers in each group is the same in both the model output data 106 and the updated output data 106-1. If the distribution between the respective output data 106 and 106-1 were different, one or more of the zero values in the matrix would include a non-zero value, indicating that the distributions of scored vs. rejected customers do not exactly correspond.

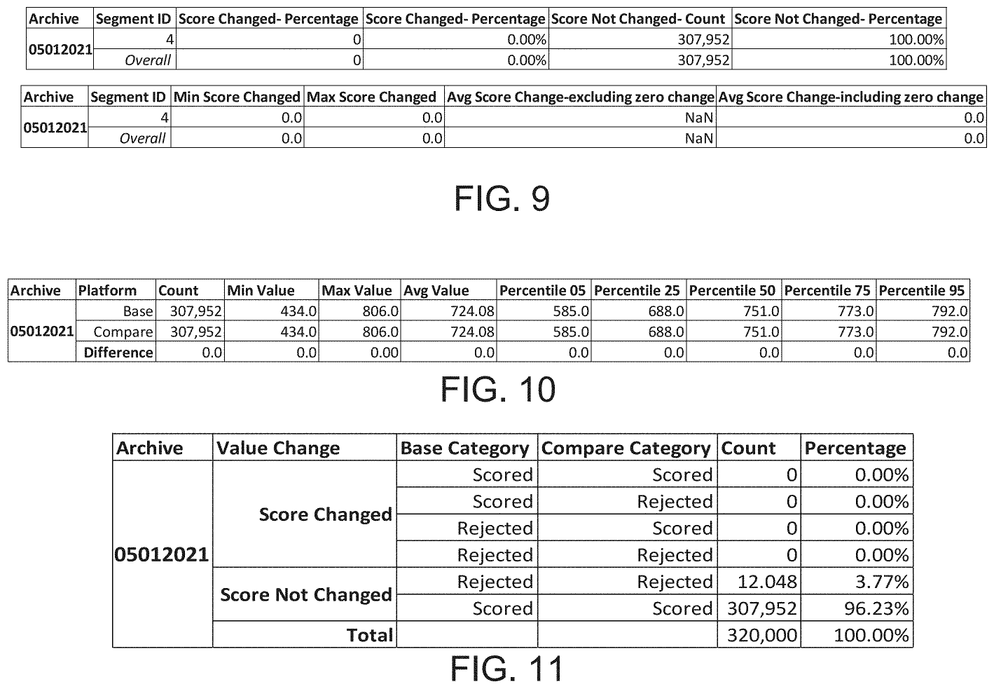

FIG. 9 illustrates an example of determining performance metrics comparing the output data 106 and the respective output data 106-1, including a number of consumers with score changes, a percentage of consumers with score change, a number of consumers with no score, a percentage of consumers with no score change, min score change, max score change, avg score change excluding zero change, avg score change including zero change. The illustrated performance metrics are determined based on data from FIG. 3 (e.g. min score change and max score change for all customers and for segment 4, which corresponds to a subset of scored customers), and data from FIG. 5 (e.g. score changed—count, score changed—percentage, score not changed—count, score not changed—percentage for all customers and for segment 4, which corresponds to a subset of scored customers). In certain examples, as illustrated in FIG. 9, data for consumers that exhibit no change between model output and updated model output are excluded from a population of consumers when determining an average score change, therefore FIG. 9 depicts values “NaN” (not a number)), since an average score change was not able to be determined from the data of FIG. 3. In other examples, data for consumers that exhibit no change are not excluded and in such embodiments, if data for all consumers exhibited no change, the average score change would be zero (0).

FIG. 10 illustrates an example of determining key model data 107 and corresponding key updated model data 107-1, including—both at the segment level (e.g., scored customer segment vs rejected customer segment) and the overall level (e.g., all customers)—a count of consumers, a minimum score, a maximum score, an average score, and percentile scores at 05, 25, 50, 75, and 95 percentiles. FIG. 10 further illustrates determining performance metrics indicating a difference, for each of the above-mentioned value pairs, a respective performance metric of a difference between the key model data 107 value and the key updated model data value 107-1.

FIG. 11 illustrates an example of determining key model data 107 and key updated model data 107-1 including a number and percentage of customers in the model output data 106 and the updated model output data 106-1. The values of the table of FIG. 11 can be determined based on the values in FIG. 7. For example, the table in FIG. 11 looks at the distribution of change between scored and rejected consumers. That is, for scoring models it gets a count of consumers with a change it gets separate counts for each of these categories: valid score to valid score, valid score to rejected, rejected to rejected, and rejected to rejected.

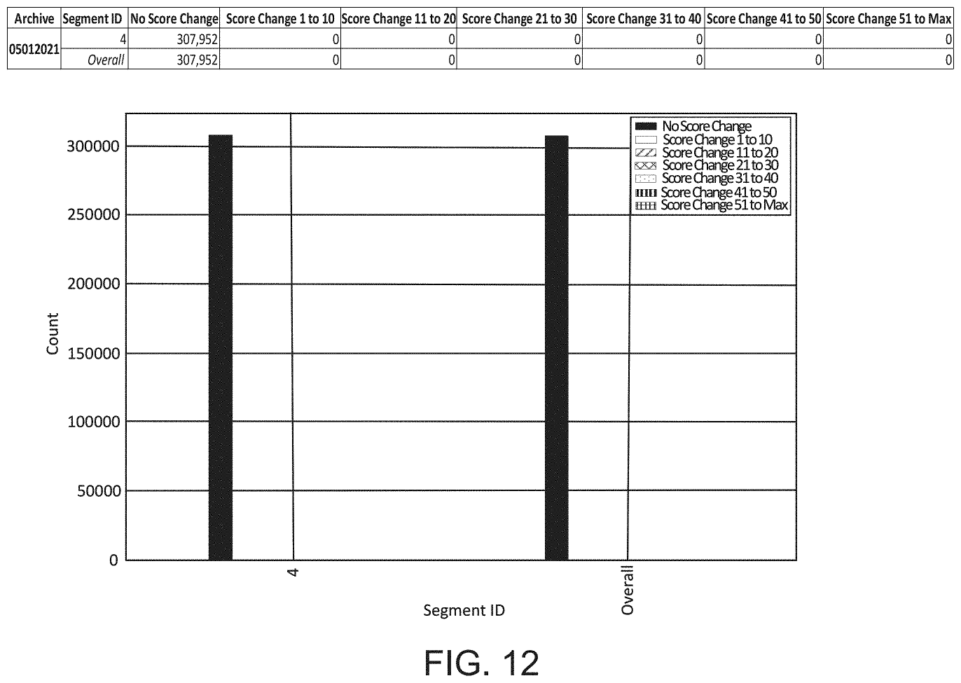

FIG. 12 illustrates, both in tabular form and graphical form, a count and percentage of consumers that did not have a score change, had a score change between various ranges, for example, from 1 to 10, 11 to 20, 21 to 30, 31 to 40, 41 to 50, and 51 to Max. The values in the table and graph of FIG. 12 can be determined based on the values in FIG. 10.

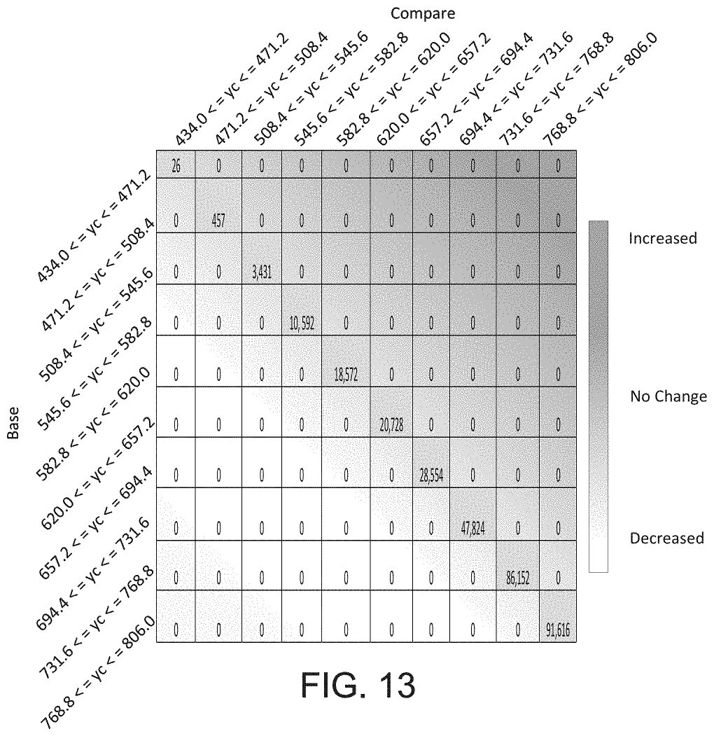

FIG. 13 illustrates an example of a compare matrix comparing a number of customers having a score change, between the outputs 601 and 601-1 of the model and the updated model, in each of a number of bins in a valid score range. The example compare matrix of FIG. 13 compares 10 equal bins, but any other number of bins may be used and a size of the bins may be varied. As illustrated in FIG. 13, the compare matrix values falling along a center diagonal line of the compare matrix indicates that the distribution of customers in each bin is the same in both the model output data 106 and the updated output data 106-1. If the distribution between the respective output data 106 and 106-1 were different, one or more of the zero values in the matrix would include a non-zero value, indicating that the distributions of customers in the set of 10 bins do not exactly correspond between the model output data 106 and the updated output data 106-1.

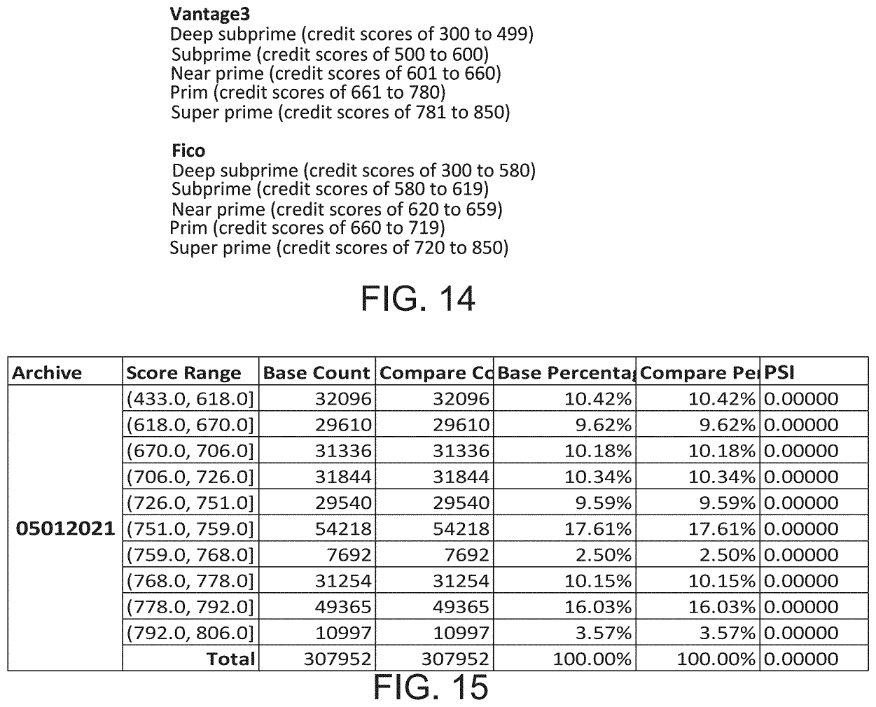

FIG. 14 illustrates score ranges for vantage (Vantage3) and FICO credit classifications. The compare matrix of FIG. 13, in some instances, instead of being divided into a predetermined number of bins, may be divided into bins corresponding to one of the credit classifications of FIG. 14. For example, the compare matrix of FIG. 13, instead of having 10 bins, could include 5 bins corresponding to “deep subprime,” “subprime,” “near prime,” “prime,” and “super prime,” score ranges as indicated in FIG. 14. In another example, the compare matrix of FIG. 13 is adapted to include 5 bins corresponding to the Vantage credit designation ranges depicted in FIG. 14.

FIG. 15 illustrates an example of determining key model data 107 and corresponding key updated model data 107-1, including—for each of the bins associated with the compare matrix of FIG. 13—a count of consumers, and a percentage of customers corresponding to each bin in both the model output data 601 and the updated model output data 601-1. FIG. 10 further illustrates determining a performance metrics indicating a difference, for each of the above mentioned value pairs, a respective performance metric of a population stability index (PSI) for each of the bins determined based on the count of consumers and/or the percentage of customers corresponding to each bin in both the model output data 601 and the updated model output data 601-1. As shown in FIG. 15, the PSI for each of the 10 bins is 0%, indicating that there was no change in either the counts or the percentages of customers in each bin between the model output data 601 and the updated model output data 601-1.

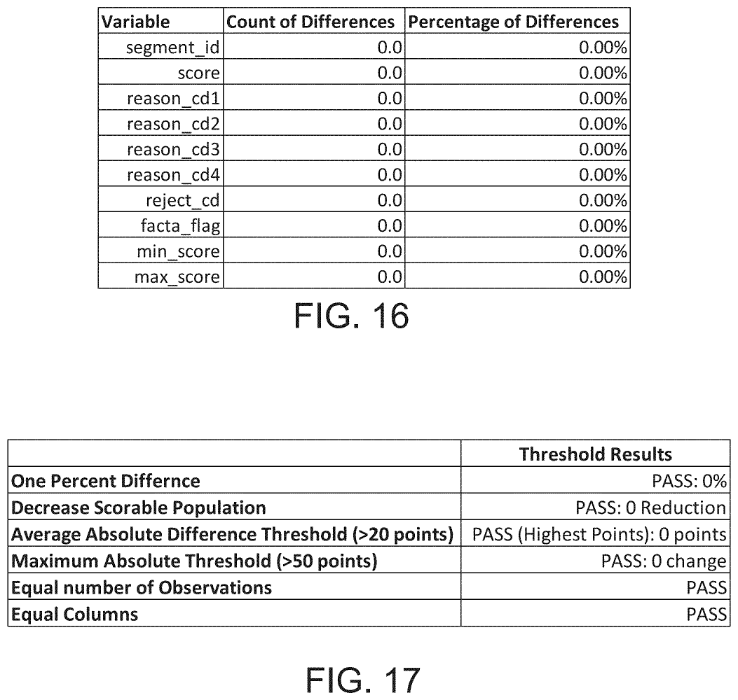

FIG. 16 illustrates an example of determining a count and percentage difference between a number of customers in various subsets from the model output data 601 to the updated model output data 601-1. For example, the reason code segment counts/percentages (e.g. reason_cd1, reason_cd2, reason_cd3, reason_cd4,). The reject_cd (reject code) variable can be taken from the values in the table of FIG. 5, which provides example reject codes F1, F2, F3, F1, and B1. In certain examples, reject codes provide a reason why a customer is rejected from being scored by a model. For example, the min_score and max_score segment counts/percentages can be taken from corresponding values in the table of FIG. 10. For example, the segment_id count/percentage can be taken from the corresponding values in the table of FIG. 7. For example, the score count/percentage can be taken from corresponding values in the table of FIG. 11.

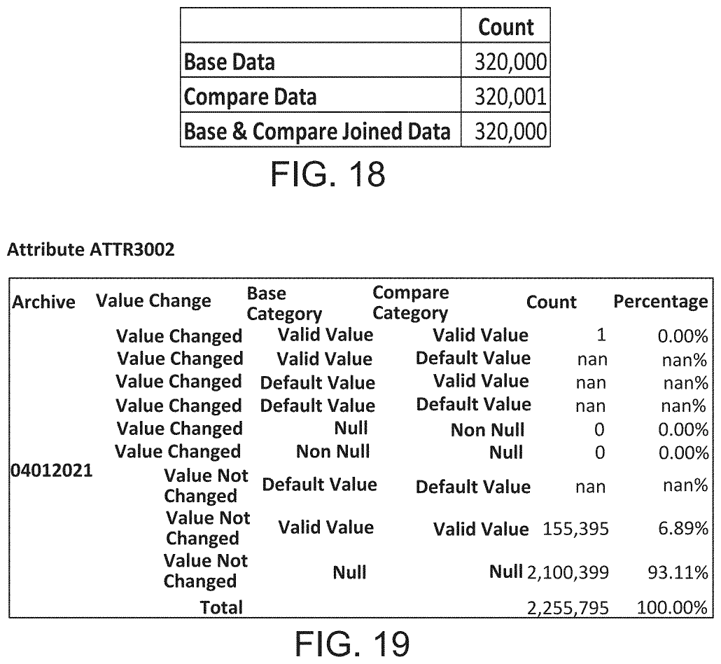

FIGS. 18-22 illustrate an example of determining key model data 107, key updated model data 107-1, and performance metric information 108 for an example attribute model.

FIG. 18 illustrates an example of determining a number of customers in the model output 106 (base data) and a number of consumers in the updated model output 106-1 (compare data). The joined data represents consumers in both the base data and the compare data.

FIG. 19 illustrates an example of comparing a distribution of change between subsets of scored and rejected consumers between the model output 106 and the updated model output 106-1. That is, for scoring and/or attribute models, the model comparison subsystem 112 determines a count of consumers with a change and separate counts for each of these categories: (a) valid value to valid value, (b) valid value to rejected, (c) rejected to rejected, and (d) rejected to rejected.

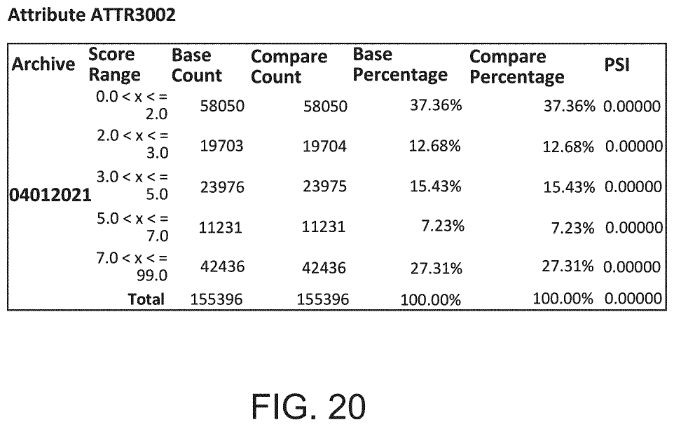

FIG. 20 illustrates an example of measuring for all attributes with differences. For example, for each of score ranges (0-2, 2-3, 3-5, 5-7, 7-99, and all scores/total), the model comparison subsystem 112 determines a count in the model output 106 (base count), a count in the updated model output 106-1 (compare count), a percentage in the model output 106 (base percentage), a percentage in the updated model output 106-1 (compare percentage). Based on these counts, the model comparison subsystem 112 determines a population stability index (PSI) for each of the score ranges as well as for the total customer population, the PSI indicating any changes in counts or percentages among score ranges between the model output 106 and the updated model output 106-1.

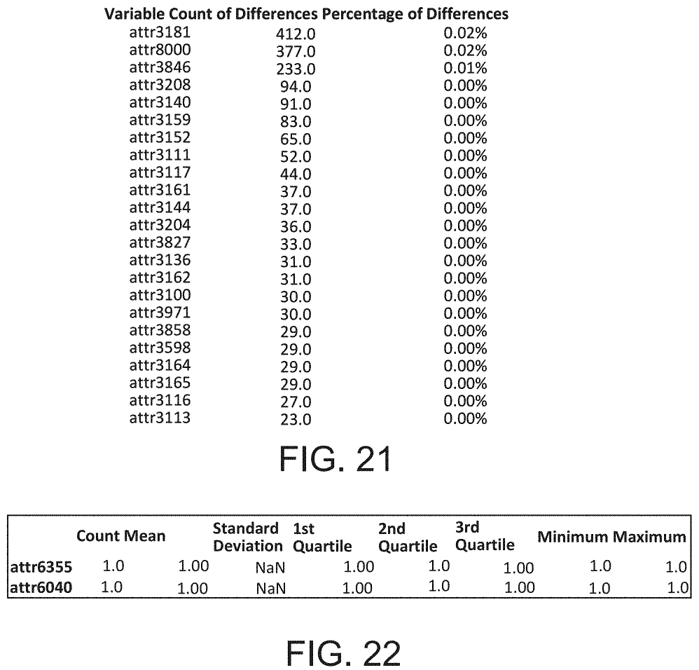

FIG. 21 illustrates an example of determining a count and percentage difference between a number of customers in various subsets from the model output data 601 to the updated model output data 601-1. For example, for each of a set of attributes, the model comparison subsystem 112 determines a difference in number/count as well as percentage of customers in a subset assigned the particular attribute.

FIG. 22 illustrates an example of calculating descriptive statistics on valid value differences for two example attributes (e.g., attr6335 and attr6040). FIG. 22 depicts the descriptive statistics in a table, which include, for each attribute, a count mean (a number of observations including differences), a mean of the differences, standard deviation of the differences, 1^{st}, 2^{nd}, and 3^{rd} quartile distributions of differences, a minimum of the differences, and a maximum of the differences.

Returning to FIG. 2, at block 212, the process 200 involves assigning, based on the performance metric comparisons in block 210, a category to the updated model from a set of categories. In some instances, model comparison subsystem 112 may generate a final diagnosis 109 or designation (e.g., pass or fail) for the updated model based on the results of each performance metric (e.g., whether each performance metric meets an associated predefined criteria) of the set of performance metrics. For example, the model comparison subsystem 112 may assign a “pass” designation to the new model if each of the set of performance metrics comparing the updated model to the model meet respective predefined criteria. In this example, the auditing system assign a “fail” designation to the updated model if one or more of the performance metrics does not meet respective predefined criteria.

At block 214, the process 200 involves modifying a computing environment or have the computing environment modified based on the category assignment from block 212. Based on the final diagnosis, the model update subsystem 114 may perform a process. In an example, the auditing system 110 may pause a data migration to a new computing platform upon which the new model will be executed responsive to determining a “fail” designation for the updated model. In this example, the model code of the model and the new model is the same on each respective computing platform, and any deviations in the results will highlight a difference in the platforms' performance. From there analyzing what the differences are will help in determining what caused the fail designation for the updated model. For example, if the differences between the model output and the new model output are in numbers of rejected entities in particular categories, then the fail designation may be caused by one or more reject reasons. For example, if the differences between the model output and the new model output are in scores, then the fail designation of the new model may be caused by one or more attributes. In certain examples, responsive to determining a “fail” designation for the updated model, the model update system 112 may iteratively change one or more parameters (e.g., weights, input data pre-processing rules, formulas, etc.) of the updated model and determine another final diagnosis through analysis of performance metrics as described above until a “pass” designation for the updated model is obtained.

In certain embodiments, the method 200 ends at block 214. In other embodiments, the process 200 proceeds from block 214 to block 216.

At block 216, in certain embodiments, the method 200 involves generating a performance report 120 indicating performance metrics of the updated model and whether each performance metric meets a predefined criterion. In certain examples, the performance report 120 further includes a final diagnosis 109 (e.g., pass or fail) for the updated model that is determined based on the designation for each of the set of performance metrics. For example, the model comparison subsystem 112 may assign a “pass” designation to the new model if each of the set of performance metrics comparing the updated model to the model meet respective predefined criteria. In this example, the model comparison subsystem 112 may assign a “fail” designation to the updated model if one or more of the performance metrics does not meet respective predefined criteria. In some instances, a statistical measure of fitness for the updated model may be determined, for example, a Komogorov-Smirnov (“KS”) test, which can be used to compare model differences.

FIG. 17 illustrates a performance report 120 for an example updated scoring model. As depicted in FIG. 17, the performance report 120 includes performance metric information 108 including a list of performance metrics including one percent difference, decrease scorable population, average absolute difference threshold (>20 points), maximum absolute threshold (>50 points), equal number of observations, and equal number of columns. One or more of these performance metrics is determined according to the example illustrations of FIGS. 3-16. As depicted in FIG. 17, the performance metric information 108 further includes an indication, for each of the listed performance metrics, an indication (“threshold results”) of whether the performance metric meets a respective predefined criteria or does not meet the respective predefined criteria. As depicted in FIG. 17, each of the performance metrics has met the respective predefined criteria as indicated by the “PASS” designation assigned to each performance metric. In other examples, however, one or more of the performance metrics does not meet a respective predefined criteria and one or more of these PASS values can be a FAIL value.

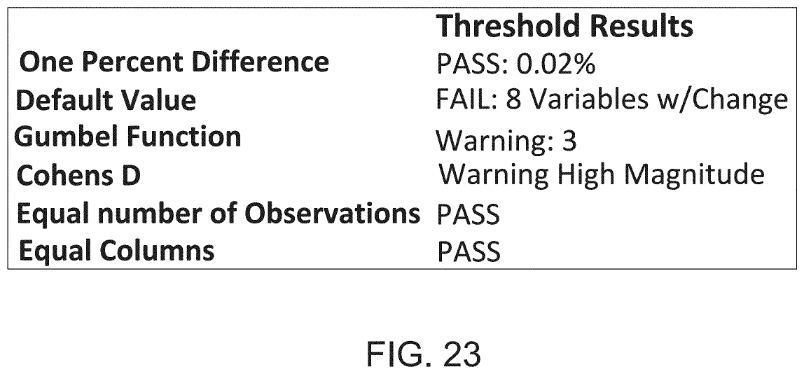

FIG. 23 illustrates a performance report 120 for an example attribute model. As depicted in FIG. 23, the performance report 120 includes performance metric information 108 including a list of performance metrics including one percent difference, default value, Gumbel function, Cohens D, Equal number of observations, and equal columns. One or more of these performance metrics can be determined according to the example illustrations of FIGS. 18-22. As depicted in FIG. 23, the performance metric information 108 further includes an indication, for each of the listed performance metrics, an indication (“threshold results”) of whether the performance metric meets a respective predefined criteria or does not meet the respective predefined criteria. As depicted in FIG. 23, each of the performance metrics has met the respective predefined criteria as indicated by the “PASS” designation assigned to each performance metric. In other examples, however, one or more of the performance metrics does not meet a respective predefined criteria and one or more of these PASS values can be a FAIL value.

Example of Computing System for Data Validation Operations

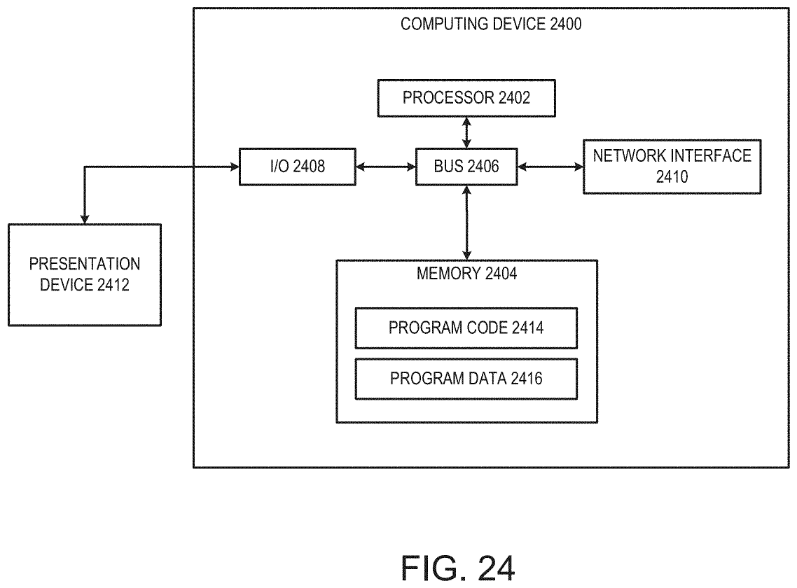

Any suitable computing system or group of computing systems can be used to perform the operations described herein. For example, FIG. 24 is a block diagram depicting an example of a computing device 2400, which can be used to implement the auditing system 110 (including the model comparison subsystem 112 and the model update subsystem 114), or any other device for executing the auditing system 110. The computing device 2400 can include various devices for communicating with other devices in the operating environment 100, as described with respect to FIG. 1. The computing device 2400 can include various devices for performing one or more operations described above with respect to FIG. 2-23.

The computing device 2400 can include a processor 2402 that is communicatively coupled to a memory 2404. The processor 2402 executes computer-executable program code stored in the memory 2404, accesses information stored in the memory 2404, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 2402 include a microprocessor, an application-specific integrated circuit, a field-programmable gate array, or any other suitable processing device. The processor 2402 can include any number of processing devices, including one. The processor 2402 can include or communicate with a memory 2404. The memory 2404 stores program code that, when executed by the processor 2402, causes the processor to perform the operations described in this disclosure.

The memory 2404 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C #, Visual Basic, Java, Python, Perl, JavaScript, ActionScript, etc.

The computing device 2400 may also include a number of external or internal devices such as input or output devices. For example, the computing device 2400 is shown with an input/output interface 2408 that can receive input from input devices or provide output to output devices. A bus 2406 can also be included in the computing device 2400. The bus 2406 can communicatively couple one or more components of the computing device 2400.

The computing device 2400 can execute program code 2414 that includes the model comparison subsystem 112 and/or the model update subsystem 114. The program code 2414 for the model comparison subsystem 112 and/or the model update subsystem 114 may be resident in any suitable computer-readable medium and may be executed on any suitable processing device. For example, as depicted in FIG. 24, the program code 2414 for the model comparison subsystem 112 and/or the model update subsystem 114 can reside in the memory 2404 at the computing device 1400 along with the program data 2416 associated with the program code 2414, such as the archive data 102, input data 103, model code 104, updated model code 104-1. Executing the model comparison subsystem 112 and/or the model update subsystem 114 can configure the processor 2402 to perform the operations described herein.

In some aspects, the computing device 2400 can include one or more output devices. One example of an output device is the network interface device 2410 depicted in FIG. 24. A network interface device 2410 can include any device or group of devices suitable for establishing a wired or wireless data connection to one or more data networks described herein. Non-limiting examples of the network interface device 2410 include an Ethernet network adapter, a modem, etc.

Another example of an output device is the presentation device 2412 depicted in FIG. 24. A presentation device 2412 can include any device or group of devices suitable for providing visual, auditory, or other suitable sensory output. Non-limiting examples of the presentation device 2412 include a touchscreen, a monitor, a speaker, a separate mobile computing device, etc. In some aspects, the presentation device 2412 can include a remote client-computing device that communicates with the computing device 2400 using one or more data networks described herein. In other aspects, the presentation device 2412 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A method that includes one or more processing devices performing operations comprising:
executing a first machine learning model on a first computing platform using input data to generate first output data;
executing a second machine learning model on a second computing platform using the input data to generate second output data, wherein the second machine learning model is generated by migrating the first machine learning model to the second computing platform;
determining one or more performance metrics based on comparing the first output data to the second output data;
classifying, based on the one or more performance metrics, the second machine learning model with a classification, wherein the classification comprises a passing classification or a failing classification; and
causing the second model to be modified responsive to classifying the second model with a failing classification.

2. The method of claim 1, wherein the second model has one or more parameters that are different from the first model.

3. The method of claim 2, wherein modifying the one or more parameters of the second model comprises modifying one or more scoring rules of the first model.

4. The method of claim 3, further comprising:
responsive to classifying the second model with the failing classification, pausing a data migration operation between the first platform and the second platform.

5. The method of claim 1, wherein the performance metrics comprise one or more of a difference count or difference percentage between the first output data and the second output data, a number or percentage of entities with scores that change between the first output data and the second output data, a minimum score change between the first output data and the second output data, a maximum score change between the first output data and the second output data, or an average score change between the first output data and the second output data.

6. The method of claim 1, further comprising:
for each of the set of determined performance metrics, compare the performance metric to a predefined criterion;
responsive to determining that the performance metric meets the predefined criteria, assign the performance metric to a first category; and
responsive to determining that the performance metric does not meet the predefined criteria, assign the performance metric to a second category,
wherein the first category comprises a pass designation and the second category comprises a fail designation.

7. The method of claim 1, wherein classifying the first model comprises assigning a category to the first model based on categories assigned to each performance metric of the set of performance metrics.

8. A system comprising:
a processing device; and
a memory device in which instructions executable by the processing device are stored for causing the processing device to perform operations comprising:
executing a first machine learning model on a first computing platform using input data to generate first output data;
executing a second machine learning model on a second computing platform using the input data to generate second output data, wherein the second machine learning model is generated by migrating the first machine learning model to the second computing platform;
determining one or more performance metrics based on comparing the first output data to the second output data;
classifying, based on the one or more performance metrics, the second machine learning model with a classification, wherein the classification comprises a passing classification or a failing classification; and
causing the second model to be modified responsive to classifying the second model with a failing classification.

9. The system of claim 8, wherein the second model has one or more parameters that are different from the first model.

10. The system of claim 9, wherein modifying the one or more parameters of the second model comprises modifying one or more scoring rules of the first model.

11. The system of claim 8, the operations further comprising:
responsive to classifying the second model with the failing classification, pausing a data migration operation between the first platform and the second platform.

12. The system of claim 8, wherein the performance metrics comprise one or more of a difference count or difference percentage between the first output data and the second output data, a number or percentage of entities with scores that change between the first output data and the second output data, a minimum score change between the first output data and the second output data, a maximum score change between the first output data and the second output data, or an average score change between the first output data and the second output data.

13. The system of claim 8, the operations further comprising:
for each of the set of determined performance metrics, compare the performance metric to a predefined criterion;
responsive to determining that the performance metric meets the predefined criteria, assign the performance metric to a first category; and
responsive to determining that the performance metric does not meet the predefined criteria, assign the performance metric to a second category,
wherein the first category comprises a pass designation and the second category comprises a fail designation.

14. The system of claim 8, wherein classifying the first model comprises assigning a category to the first model based on categories assigned to each performance metric of the set of performance metrics.

15. A non-transitory computer-readable storage medium having program code that is executable by a processor device to cause a computing device to perform operations comprising:
executing a first machine learning model on a first computing platform using input data to generate first output data;
executing a second machine learning model on a second computing platform using the input data to generate second output data, wherein the second machine learning model is generated by migrating the first machine learning model to the second computing platform;
determining one or more performance metrics based on comparing the first output data to the second output data;
classifying, based on the one or more performance metrics, the second machine learning model with a classification, wherein the classification comprises a passing classification or a failing classification; and
causing the second model to be modified responsive to classifying the second model with a failing classification.

16. The non-transitory computer-readable storage medium of claim 15, wherein the second model has one or more parameters that are different from the first model.

17. The non-transitory computer-readable storage medium of claim 16, wherein modifying the one or more parameters of the second model comprises modifying one or more scoring rules of the first model.

18. The non-transitory computer-readable storage medium of claim 15, the operations further comprising:
responsive to classifying the second model with the failing classification, pausing a data migration operation between the first platform and the second platform.

19. The non-transitory computer-readable storage medium of claim 15, wherein the performance metrics comprise one or more of a difference count or difference percentage between the first output data and the second output data, a number or percentage of entities with scores that change between the first output data and the second output data, a minimum score change between the first output data and the second output data, a maximum score change between the first output data and the second output data, or an average score change between the first output data and the second output data.

20. The non-transitory computer-readable storage medium of claim 15, the operations further comprising:
for each of the set of determined performance metrics, compare the performance metric to a predefined criterion;
responsive to determining that the performance metric meets the predefined criteria, assign the performance metric to a first category; and
responsive to determining that the performance metric does not meet the predefined criteria, assign the performance metric to a second category,
wherein the first category comprises a pass designation and the second category comprises a fail designation.
